(19) United States
(12) Patent Application Publication
(10) Pub. No.: US 2015/0032521 A1
(43) Pub. Date: Jan. 29, 2015

(54) AGGREGATION OF SAVINGS DATA FROM PAST TRANSACTIONS

(71) Applicant: Bank of America Corporation, Charlotte, NC (US)

(72) Inventors: Matthew A. Calman, Charlotte, NC (US); Carrie A. Hanson, Charlotte, NC (US); Susan S. Thomas, Gastonia, NC (US); Jason Blackhurst, Charlotte, NC (US); Katherine Dintenfass, Charlotte, NC (US); Laura C. Bondesen, Charlotte, NC (US)

(73) Assignee: Bank of America Corporation, Charlotte, NC (US)

(21) Appl. No.: 13/952,448

(22) Filed: Jul. 26, 2013

(51) Int. Cl. G06Q 20/10; G06Q 30/02

(52) U.S. Cl. CPC G06Q 20/10; G06Q 30/0215
USPC 705/14.17; 705/39

(57) ABSTRACT

Embodiments of the invention are directed to apparatus, methods, and computer program products for aggregation of savings data from e-receipts. In some embodiments, an apparatus is configured to receive a request from a customer associated with a financial institution account; retrieve an information based on the request from a structured database associated with a customer's financial institution account, wherein the information includes a product purchase associated with the customer's purchase transaction; identify a savings amount associated with the product purchase; and provide the savings amount to the customer.

### BACKGROUND

There is a need for a system to aggregate savings data associated with a customer's transaction history from corresponding e-receipts.

### BRIEF SUMMARY

The present invention embraces an apparatus for aggregating savings data from past transactions to receive a request from a customer associated with a financial institution account. In response to receiving the request, the apparatus may then retrieve an information based on the request from a structured database associated with a customer's financial institution account, wherein the information includes a product purchase associated with the customer's purchase transaction. The apparatus may then identify a savings amount associated with the product purchase and then provide the savings amount to the customer.

In some embodiments, the request includes a transaction date range, a searchable query, and a savings source, wherein savings source includes a redeemable coupon, a promotional offer, or loyalty points.

In some embodiments, the savings amount includes individual savings associated with each product purchase in the customer's purchase transaction.

In some embodiments, the savings amount includes an aggregate of individual savings associated with each product purchase in the customer's purchase transaction.

In some embodiments, the savings amount is a percentage of a price amount associated with each product purchased.

In some embodiments, the savings amount is a percentage of a total transaction amount associated with the customer's purchase transaction.

In some embodiments, the savings amount is based on a product name, a product type, a product category, or a product brand.

In some embodiments, the savings amount is provided to the customer based on a transaction method, wherein transaction methods include a debit card, a credit card, or cash.

In some embodiments, the savings amount is based on an entity associated with the transaction method, wherein the entity is a financial institution.

In some embodiments, the apparatus initiates the presentation of a first customer interface to the customer enabling the customer to enter the request.

In some embodiments, the apparatus initiates the presentation of a second customer interface to the customer based on the request enabling the customer to view the information retrieved.

In some embodiments, the second customer interface includes an export option.

In some embodiments, the module enables the customer to categorize the product purchase.

In some embodiments, the module is further configured to aggregate the savings amount in each category.

In some embodiments, the module is further configured to provide an incentive to the customer based on the savings amount.

In some embodiments, the incentive is based on whether the savings amount has crossed a pre-defined threshold, wherein the pre-defined threshold is specified by the financial institution.

In some embodiments, the pre-defined threshold is made modifiable by the customer.

In some embodiments, incentive includes a discount, a redeemable coupon, a new account incentive, or a credit card reward.

In some embodiments, a method for aggregation of savings from past transactions is presented. The method comprising: receiving a request from a customer associated with a financial institution account; receiving a request from a customer associated with a financial institution account; retrieving an information based on the request from a structured database associated with a customer's financial institution account, wherein the information includes a product purchase associated with the customer's purchase transaction; identifying a savings amount associated with the product purchase; and providing the savings amount to the customer.

In some embodiments, a computer program product for aggregation of savings from past transactions is presented, the computer program product comprising a non-transitory computer-readable medium comprising code causing a first apparatus to: receive a request from a customer associated with a financial institution account; retrieve an information based on the request from a structured database associated with a customer's financial institution account, wherein the information includes a product purchase associated with the customer's purchase transaction; identify a savings amount associated with the product purchase; and provide the savings amount to the customer.

### BRIEF DESCRIPTION OF THE FIGURES

Having thus described embodiments of the invention in general terms, reference will now be made to the accompanying drawings, where:

FIG. 1 illustrates the system environment for retrieval of electronic communications relating to customer purchase transactions, parsing of data within such electronic communications into structured data, and inclusion of such data into online banking.

FIG. 2 illustrates a high level process flow for aggregation of savings data from past transactions.

FIG. 3A illustrates an exemplary first interface of the system for aggregation of savings data from e-receipts.

FIG. 3B illustrates an exemplary second interface of the system for aggregation of savings data from e-receipts.

FIG. 4 illustrates the system environment for credit source recommendation based on SKU level data analysis.

### DETAILED DESCRIPTION OF AN EMBODIMENT OF THE PRESENT INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a customer to establish an account with the entity. An “account” may be the relationship that the customer has with the entity. Examples of accounts include a deposit account, such as a transactional account (e.g. a banking account), a savings account, an investment account, a money market account, a time deposit, a demand deposit, a pre-paid account, a credit account, a non-monetary customer profile that includes only personal information associated with the customer, or the like. The account is associated with and/or maintained by an entity. In other embodiments, an “entity” may not be a financial institution.

In some embodiments, the “customer” may be an account holder or a person who has an account (e.g. banking account, credit account, or the like) at the entity. In alternate embodiments, the “customer” may be a buyer, a merchant (e.g. a business, a vendor, a service provider, or the like).

As used herein, the “mobile device” may be a wide variety of computing devices. In some embodiments, the mobile device may refer to a smart phone, a laptop, a tablet, or the like. In other embodiments, the mobile device may refer to a desktop or rack-mounted computing device.

The past few years has seen an increase in the growth of online banking, whereby financial institution customers, (such as bank and credit card customers), may view financial account transaction data, perform online payments and money transfers, view account balances, and the like. A current drawback with online banking is that transactional level detail for a given purchase by the customer using a bank card issued by the financial institution is limited. Further, transaction level detail for a transactions conducted by the customer using cash or a third party bank card is almost non-existent.

In the past few years, there has been an increase in the amount of electronic information provided by merchants to customers regarding purchase of products and services. In the online purchase context, various electronic communications may be provided to the customer from the merchant relative to a purchase. For example, following an online purchase, the merchant may provide the customer an electronic order confirmation communication. The order confirmation may be sent to the customer's computer and displayed in a web browser application. The web browser application typically allows the customer to print a hard copy of the order confirmation and to save the confirmation electronically. The merchant will also typically send an email containing the order confirmation to the customer's designated email account. The order confirmation is essentially an e-receipt for the online purchase. The order confirmation includes detailed information regarding the products or services purchased. For example, in the case of a product, the order confirmation may include stock keeping unit “SKU” code level data, as well as other parameters, such as order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like. The order confirmation also includes information about the merchant, such as name, address, phone number, web address, and the like. For most online transactions, the merchant will send at least one second communication confirming shipment of the order. The order shipment confirmation is typically also sent via email to the customer and typically includes the same information as the order confirmation, and in addition, shipping date, tracking number, and other relevant information regarding the order and shipment parameters.

Many merchants now also provide e-receipts to customers shopping at brick and mortar locations. In general, at the point of sale, the customer may have previously configured or may be asked at the time of sale as to whether she wishes to receive an e-receipt. By selecting this option, the merchant will send an electronic communication in the form of an e-receipt to the customer's designated email address. Here again, the e-receipt will typically include a list of services and/or products purchased with SKU level data, and other parameters, as well as information about the merchant, such as name, address, phone number, store number, web address, and the like.

Various merchants now also provide online customer accounts for repeat customers. These online customer accounts may include purchase history information associated with the customer accessible by the customer via ID and passcode entry. Purchase history provides detailed information about services and products purchased by the customer including information found on order confirmations and shipping confirmations for each purchase. Online customer accounts are not limited to online purchases. Many merchants also provide online customer accounts for customers that purchase services and products at brick and mortar locations and then store these transactions in the customer's online account.

For the most part, order confirmations, shipping confirmations, e-receipts, and other electronic communications between merchants and customers are used only by the customer as proof of purchase and for monitoring receipt of purchased items (i.e., for archival purposes). However, there is significant data that can be gleaned from this electronic information for the benefit of the customer, so that the customer may have detailed information regarding purchase history, spending, and the like.

The lack of detailed information regarding a given transaction in the online banking environment limits a customer's ability to ascertain a larger picture of purchase history and financial transaction information. As a first example, if a customer makes several purchases within a short time period with a particular merchant, all that the customer will see in online banking for each purchase is an overall dollar amount, the merchant name, and date of the purchase transaction. If the customer cannot recall what a particular purchase was for or whether it was a legitimate transaction, the customer cannot view details regarding the purchase via online banking to aid in the inquiry. Instead, the customer must locate and review receipts from the purchases and match them by date and/or total purchase amount to online banking data to perform such analysis.

Lack of detailed purchase information also hinders use of other financial tools available to the customer in online banking, such as budget tools. In general, budget tools divide expenses into various categories, such as food, clothing, housing, transportation, and the like. It is typically advantageous to provide such budget tools with online banking information to populate these various categories with spend information. However, this is difficult where specifics regarding a purchase made by the merchant (such as SKU level data) are not provided by the merchant to the financial institution for a given financial transaction. As many stores provide a wide variety of services and products, such as in the case of a “big box” store that provides groceries, clothing, house hold goods, automotive products, and even fuel, it is not possible to dissect a particular purchase transaction by a customer at the merchant for budget category purposes. For this reason, many current online budgeting tools may categorize purchases for budgeting by merchant type, such as gas station purchases are categorized under transportation and grocery store purchases are categorized under food, despite that in reality, the purchase at the gas station may have been for food or the purchase at the grocery store could have been for fuel. Alternatively, some budget tools may allow a customer to parse the total amount of a purchase transaction between budget categories by manually allocating amounts from the purchase transaction between each budget category. This requires added work by the customer and may be inaccurate if the customer is not using the receipt in making such allocations.

Customer cash purchases are also problematic for integration of customer purchase transactions into online banking In a cash transaction, the customer may initially withdraw cash from a financial account and then use the money for a purchase. In this instance, the customer's online banking will have no information whatsoever regarding the purchase transaction with a merchant, as there is no communication regarding the purchase transaction between the financial institution and the merchant. For example, if the customer uses cash to purchase fuel at a gas station, the financial institution has no way of determining that the purchase transaction occurred and cannot use such information for notifying customer of spending or budgeting regarding the fuel purchase.

In addition, information associated with customer transactions using a third party bank card (debit card, credit card, check card, or the like) is non-existent. In some embodiments, for transactions conducted using a third party credit card, the only information available to the financial institution may be an online money transfer involving the customer paying off the balance associated with the credit card issued by the third party.

In light of the above, the current invention contemplates use of e-receipt data, electronic communication data between a merchant and customer, and recurring transactions available in the customer's financial account statement in order to augment transaction data in online banking and incentivize the use of a bank card issued by the financial institution by providing one or more discount options to the customer. The general concept is to retrieve such electronic communications from the customer, parse the data in these electronic communications, associate the data from the electronic communications with the corresponding online purchase transaction data, and provide recommendations accordingly.

An initial barrier to integration of electronic communication data received by a customer from a merchant regarding a purchase transaction for inclusion into online banking is data format. Online banking data is in a structured form. Financial institutions currently use a data structure conforming to Open Financial Exchange “OFX” specifications for the electronic exchange of financial data between financial institutions, businesses and customers via the Internet. E-receipts, such as electronic order confirmations, shipment confirmation, receipts, and the like typically do not comply with a uniform structure and are generally considered to include data in an “unstructured” format. For example, while one merchant may provide data in an electronic communication to a customer in one format, another merchant may use a completely different format. One merchant may include merchant data at the top of a receipt and another merchant may include such data at the bottom of a receipt. One merchant may list the purchase price for an item on the same line as the description of the item and list the SKU number on the next line, while another merchant may list the data in a completely opposite order. As such, prior to integration of electronic communications relating to customer purchases into online banking, the data from such electronic communications must be parsed into a structured form.

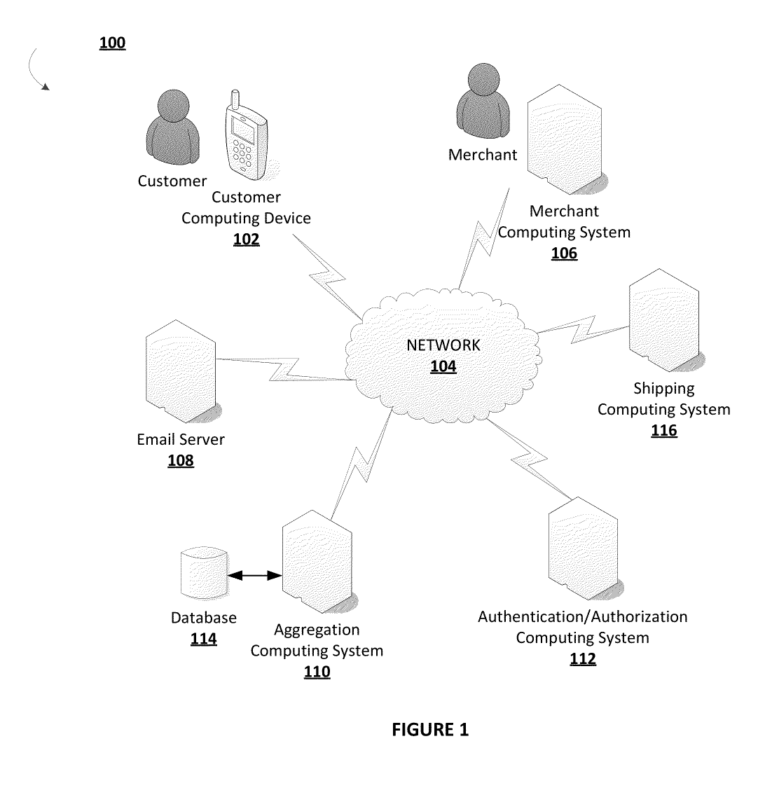

FIG. 1 is a diagram of an operating environment 100 according to one embodiment of the present invention for retrieval of electronic communications relating to customer purchase transactions, parsing of data within such electronic communications into structured data, and inclusion of such data into online banking. As illustrated a consumer maintains one or more computing devices 102, such as a PC, laptop, mobile phone, tablet, television, or the like that is network enabled for communicating across a network 104, such as the Internet, wide area network, local area network, Bluetooth network, near field network, or any other form of contact or contactless network. Also, in the operating environment, is one or more merchant computing systems 106 that is network enabled. In the context of an online shopping experience, the merchant computing system 106 may be one or more financial transaction servers that, either individually or working in concert, are capable of providing web pages to a customer via the network 104, receiving purchase orders for items selected by the customer, communicating with the customer and third party financial institutions to secure payment for the order, and transmitting order confirmation, and possibly shipping confirmation information, to the customer via the network 104 regarding the purchase transaction. In the context of an in-store purchase, the merchant computing system 106 may include a point of sale terminal for scanning or receiving information about products or services being purchased by the customer and communicating with the customer and third party financial institutions to secure payment for the order. Either the point of sale device or a connected merchant server may be used to communicate order confirmation or purchase confirmation information to the customer related to the purchase transaction. If the customer has an online account with the merchant, the merchant computing system may also log the transaction information into the customer's online account.

In general, the merchant computing system will provide the customer with information relating to the purchase transaction. In the context of an online purchase, the communications may take the form of purchase order confirmations provided as a web page or as an email or as both. In some, embodiments, the merchant computing system may provide a web page purchase order confirmation, and advise the customer to either print, electronically save, or book mark the confirmation web page. The purchase order confirmation is essentially an e-receipt for the online purchase transaction. The order confirmation includes detailed information regarding the products or services purchased, such as for example, in the case of a product, SKU code level data, as well as other parameters associated with the product, such as type/category, size, color, and the like, as well purchase price information, information associated with the merchant, and the like. The merchant computing system may also send other subsequent communications, such as communications confirming shipment of the order, which typically includes the same information as the purchase order confirmation, and in addition, shipping date, tracking number, and other relevant information regarding the order. In the context of an in-store purchase, the merchant computing system may send an e-receipt comprising information similar to that of the purchase order confirmation. In some instances, the customer may actually receive a paper receipt, which the customer may choose to scan into an electronic form and save in a storage device associated with the customer computing device 102. In the description herein, the term e-receipt may be used generically to refer to any communication or document provided by a merchant to a customer relating to a purchase transaction.

For a plurality of different purchase transactions, a customer may include purchase transaction related data (e.g., order confirmations, shipping confirmations, e-receipts, scanned receipts, typed or handwritten notes, invoices, bills of sale, and the like) in various locations and in various forms. The purchase related data could be stored in a storage device associated with the customer computing device 102, or in an email server 108, or in a customer's account at the merchant's computing system 106. Furthermore, as mentioned, the purchase transaction related information is in an unstructured format. Each merchant may use a customized reporting format for the communications, whereby various data relating to the purchase transaction may be placed in different sequences, different locations, different formats, etc. for a given merchant. Indeed, a given merchant may even use different data formatting and structuring for different communications with the customer (e.g., order confirmation, shipping, confirmation, e-receipt, online customer account information, and the like).

To aggregate and structure data related to purchase transactions, the operating environment further comprises an aggregation computing system 110. The aggregation computing system 110 is operatively connected to at least the customer computing device 102, the merchant computing system 106, and the email server 108 via the network 104. The aggregation computing system 110 is configured to initially search and locate electronic communications associated with purchase transactions made by the customer, in for example, the customer's email, computer storage device, online accounts, and the like. For this purpose, the system may optionally include an authentication/authorization computing system 112 that comprises security IDs and passwords and other security information associated with the customer for accessing customer's email, storage devices, and customer online accounts.

Regarding email extraction, aggregation computing system 110 initially gains access to the customer's email accounts and retrieves email message headers comprising data fields relative to the email message, such as sender, subject, date/time sent, recipient, and the like. In some embodiments, the aggregation computing system 110 accesses the emails directly. In other embodiments, the aggregation computing system 110 may run search queries of the email database based on known merchant names and/or phrases associated with e-receipt information, such as “receipt,” “order confirmation,” “shipping confirmation,” or the like. Once emails are extracted, further filtering may occur to locate relevant emails. Examples of further filtering may be searches based on known online merchants, third parties known to provide e-receipts, text in the email message subject line that corresponds to known order confirmation subject line text or known shipping confirmation subject line text, such as an email message sent with a subject line containing the text “purchase,” “order,” “ordered,” “shipment,” “shipping,” “shipped,” “invoice,” “confirmed,” “confirmation,” “notification,” “receipt,” “e-receipt,” “ereceipt,” “return,” “pre-order,” “pre-ordered,” “tracking,” “on its way,” “received,” “fulfilled,” “package,” and the like.

Based on the email header analysis, the message bodies for emails of interest may then be accessed. The retrieved email message bodies for the identified email messages of interest are parsed to extract the purchase transaction information and/or shipping information contained therein. Such parsing operation can occur in a variety of known ways. However, because the text contained in email message bodies is un structured (as opposed to the structured tagged elements in a hypertext markup language (HTML) web page which delineate and make recognizable the various fields or elements of the web page), in one embodiment predefined templates are used that have been specifically created to identify the various individual elements or entities of interest in a given email from an online merchant. Use of these predefined templates to parse a retrieved email message body occurs within aggregation computing system 110. Because it is known from header information which merchant sent the email message of interest and whether the email message is a purchase order confirmation or a shipping confirmation from either the header or the message body information, a template specific to the merchant and type of confirmation may be used. Still further, because email message bodies can, as is known in the art, be in either a text or HTML format, a template specific to the type of email message body format may be used in some embodiments.

As an example, for each merchant there are typically four different parsing templates which can be used for electronic communications relating to purchase transactions: i) a text order confirmation template; ii) an HTML order confirmation template; iii) a text shipping confirmation template; and iv) an HTML shipping confirmation template. Where the email is an e-receipt from a brick and mortar purchase, another template may be used that is specific to the merchant. For some online merchants there are greater or fewer templates depending upon what are the various forms of email messages a given online merchant typically sends. Regardless of the number of templates for a given merchant, each template is specific as to the known particular entities typically included and the order they typically occur within each type of email confirmation message sent by that merchant.

The above describes parsing of email purchase order confirmation, shipping confirmation, or e-receipt data. As mentioned, a customer may scan and save paper receipts, typed or handwritten notes, invoices, bills of sale, and the like in a storage device or print and save purchase order and shipping confirmation communications sent to the customer by the merchant via a web page. In this instance, the aggregation computing system 110 may first perform optical character recognition “OCR” on the scanned or printed receipts prior to performing the processing performed above. Further, a customer may maintain an online account with a merchant containing purchase data information. In this instance, the aggregation computing system 110 will access the data online via communication with merchant computing system to retrieve this data. The aggregation computing system 110 may use column and/or row headers associated with the online data to parse the data, or it may use procedures similar to the above and discussed below to parse the data into appropriate fields.

Returning to data processing procedures, in some embodiments, context-free grammars “CFGs” are used to parse fields from purchase transaction data. In some embodiments, instead of using grammars for parsing natural language (e.g., English) structures, the system may use defined smaller grammars describing a particular message format, for example: “(Greetings from merchant)(Details about order)(Details about item 1)(Details about item 2) . . . (Details about item N)(Tax and totals calculation),” and the like. Further, the CFGs may be individually defined, such as in a Backus-Naur Form (BNF) format, or templates may be used for data extraction. In instances, where templates are used, these created templates are grammar and can be converted by known tools, such as Another Tool for Language Recognition “ANTLR”, into mail-specific grammars or e-receipt-specific grammars or online customer account information-specific grammars. ANTLR is then used again to convert these grammars into extraction parsers, which can be used by the aggregation computing system 110 to parse the email message bodies, e-receipt bodies, online data, etc. to extract the entities of interest from them. Examples of such extracted entities include merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like.

Other extraction parsers may be used, such as regular expression extraction, which can be used as a brute force pattern matching approach across the purchase information record. With this technique, each word in a given purchase order record is matched against a set of rules. If the rules are met, the piece of text matching the set of rules is returned. For example, shipping companies frequently use a 21 digit tracking number beginning with “1Z” or “91.” The aggregation computing system 110 may scan an entire purchase information record to find a 21 digit number with “1Z” or “91” as the first 2 digits. The matched text can then be extracted and used to determine shipping information.

In another embodiment, an HTML document object model (DOM) approach may be used to parse purchase data records. For example, the message body of an email shipping notification may contain HTML code with tags for order, shipping and/or tracking information. The aggregation computing system 110 may use these tags to identify the shipping and/or tracking information for extraction.

Once relevant information is extracted from communications between the customer and merchant regarding purchase transactions, it is stored in purchase data records in a structured database 114.

As is understood, once the purchase transaction data has been extracted, various information regarding a particular purchase transaction is now known, such as merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like. This data can be further enriched with additional and/or updated information associated with products or services within the data. For example, the data may be enriched with updated shipping and delivery information from a shipping company computer system 116, product images, information about product returns, warranty information, recall information, and the like. In particular, the aggregation computing system 110 may (1) communicate with the merchant and/or shipping company to update the shipping and delivery information extracted and stored in the database, (2) may search the merchant or the web in general to retrieve product images, and/or (3) communicate with merchant for return policies, warranties, insurance, recalls, and the like.

The above is a description of an aggregation computing system 110 according to one embodiment of the present invention. An example of an aggregation computing system 110 is described in U.S. Published Patent Application No. 2013/0024525 titled Augmented Aggregation of Emailed Product Order and Shipping Information, the contents of which are incorporated herein by reference.

The present invention embraces a system that aggregates savings data from e-receipts. In some embodiments, the system is configured to receive a request from a customer associated with a financial institution account. For example, the customer may request information to view purchase transactions with a coupon/promotional subscription to a wholesale merchant to re-evaluate the subscription. In response to the request, the system may retrieve information based on the request from a structured database associated with a customer's financial institution account, wherein the information includes a product purchase associated with the customer's purchase transaction. In response to retrieving the information, the system may further identify a savings amount associated with the product purchase and provide the savings amount to the customer. In one aspect, the product purchase may be categorized based on at least one of a product type, product brand, product price amount, or the like. In some embodiments, the savings amount identified may exported to a second apparatus for further analysis, such as a budgetary investigation.

In one aspect, the request may include a transaction date range, a searchable query, and a savings source, wherein savings source includes a redeemable coupon, a promotional offer, or loyalty points. In some embodiments, the savings amount includes individual savings associated with each product purchase in the customer's purchase transaction. In some other embodiments, the savings amount includes an aggregate of individual savings associated with each product purchase in the customer's purchase transaction. In alternative embodiments, the savings amount is a percentage of a price amount associated with each product purchased. In one aspect, the savings amount is a percentage of a total transaction amount associated with the customer's purchase transaction. In another aspect, the savings amount is based on a product name, a product type, a product category, or a product brand. In one aspect, the savings amount is provided to the customer based on a transaction method, wherein transaction methods include a debit card, a credit card, or cash.

In one aspect, the system initiates the presentation of a first customer interface to the customer enabling the customer to enter the request. In some embodiments, the request may be a searchable query. For example, the customer may want to search for a particular merchant where he/she has received savings. In some other embodiments, the request may be a transaction date range. For example, the customer may want to view savings amount received within a particular time period. In response to the request, the system may initiate the presentation of a second interface to the customer. In some embodiments, the second interface may include one or more product information retrieved by the system from the structured database. In one aspect, the second interface may include an export option. The customer may use the export option to overlay the savings information on to the customer's budget/expenditure analysis.

In some embodiments, the system may provide an incentive to the customer based on whether the savings amount has crossed a pre-defined threshold, wherein the pre-defined threshold is made modifiable by the customer. For example, if the customer's savings amount associated with a preferred merchant has crossed a pre-defined threshold, the system may be configured to provide an incentive to the customer such as a redeemable coupon, a discount, or the like.

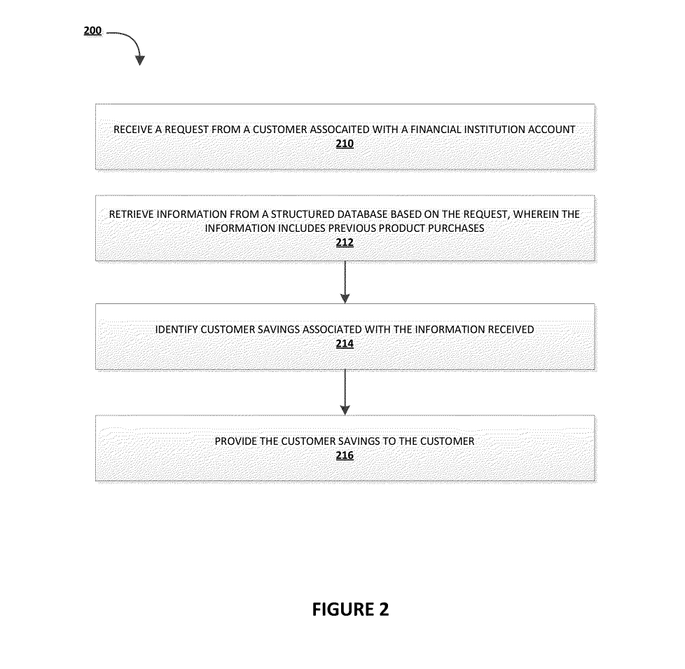

FIG. 2 illustrates a high level process flow 200 for aggregation of savings data from e-receipts. In some embodiments, the system may receive a request from a customer associated with a financial institution account, as shown in block 210. In one aspect, the request may be a transaction date range. For example, the customer subscribes to a redeemable coupon book at a monthly subscription rate of $25. The following month, while analyzing expenses, the customer may decide to find out if the monthly subscription was actually worth it. In such situations, the customer may specify a transaction date range to request information from the structured database to identify e-receipts of previous product purchases during that time period. In response to retrieving the previous product purchases, the system may identify a savings amount associated with each of the previous product purchases and provide an aggregated total to the customer. In another aspect, the request may be a searchable query. For example, the customer may want to analyze expenses and savings associated with previous electronic product purchases. In such situations, the customer may enter a search query (e.g., electronics) to request information from the system. In some other embodiments, the request may be a combination of a transaction date range and a searchable query.

In response to a customer request, the system may retrieve information from a structured database associated with the customer's financial institution account, as shown in block 212. In some embodiments, the information may include a previous product purchase as listed in the e-receipt associated with the customer's purchase transaction. In response to retrieving the information, the system may then identify a savings amount associated with the purchase transaction, as shown in block 214. In some embodiments, the savings amount may include individual savings associated with each product purchase in the transaction. In some other embodiments, the savings amount may include an aggregate of individual savings associated with each product purchase in the transaction. Typically, the customer receives a savings amount on a purchase transaction based on at least an application of a discount, a redeemable coupon, a promotional sale, a special offer, or the like. In some embodiments, the savings amount associated with each product may be a percentage of the price amount associated with the product. In some other embodiments, the savings amount may be a percentage of the total transaction amount. In one aspect, the savings amount may be a specific to at least one of a product name, a product type, a product category, a product brand, or the like. In another aspect, the savings amount may be specific to a transaction method such as a debit card, a credit card, a check card, cash, or the like. In alternative embodiments, the savings amount may be specific to the entity associated with the transaction method. In some embodiments, the savings amount may be listed on the e-receipt for each individual product associated with the purchase transaction. In some other embodiments, the savings amount may be listed on the e-receipt as an aggregate of savings associated with each individual product.

In some embodiments, the system may enable the customer perform a cross evaluation of savings associated with two of more merchants. For example, the customer may have purchased a TV from a wholesale retail store R1 with an annual subscription fee. In such situations, the system may enable the customer to compare the price of the product purchased based on the SKU level detail as received from the structured database with another merchant M1 who offers the same product at a different price amount. In some other embodiments, the system may enable the customer the compare the savings amount for a product purchased in-store with the same product purchased in-store. In some other embodiments, the system may recommend bank cards based on the savings amount. For example, the customer may use a financial institution bank card BC1 to purchase groceries on a weekly basis. The system may recognize that the customer has saved $15 the previous week and recommend a financial institution bank card BC2 which provides cash back offers for purchase types and at specific merchant locations. In some embodiments, the system may provide the customer with a savings amount on a periodic basis to see how the savings affect the overall budget.

In one aspect, the system may enable the customer to categorize the previous product purchases, wherein categorizing further includes grouping products based on at least a product type, product brand, or a product amount. In response to categorizing the products, in some embodiments, the system may aggregate the savings amount associated with each product for every category. For example, the customer may have purchased a DVD player, a high definition TV, a baseball bat, a pair of cleats, a box of cereal, and a box of eggs. The system may enable the customer to group the DVD player and the high definition TV into “electronic products”, the baseball bat and the pair of cleats into “sports gear”, and the box of cereal and the box of eggs into “groceries”. If the customer purchased the DVD player at a sale price saving $22, the high definition TV at the promotional offer saving $50, the baseball bat with a redeemable discount coupon saving $5, and the box of cereal at a special offer saving $2, the system may aggregate the customer savings for individual categories (e.g., electronic products savings—$72, sports gear—$5, groceries—$2). In some other embodiments, the system may aggregate a total savings amount regardless of product categorization (e.g., total savings—$79).

In response to categorizing the information, the system may provide the savings amount to the customer, as shown in block 230. In some embodiments, the customer may utilize the savings information to perform a budgetary analysis periodically, set a savings goal and view progress towards the goal, re-evaluate coupon subscriptions, or the like.

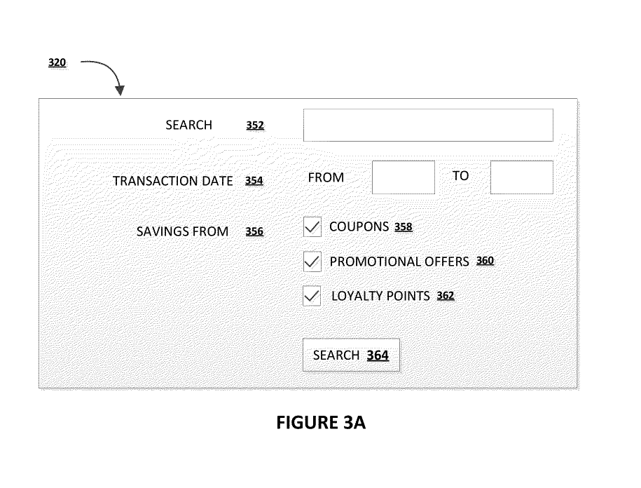

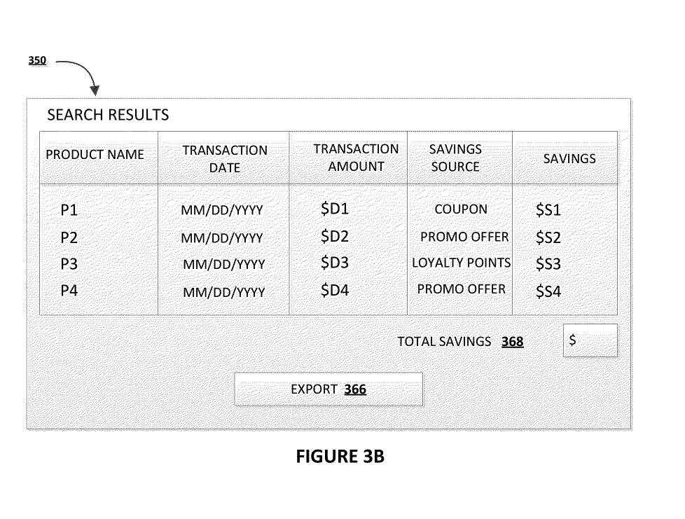

FIG. 3A illustrates an exemplary first interface 320 associated with the system for the customer request. In some embodiments, the first interface may enable the customer to enter text in a search field 352. Typically, the system retrieves information associated with the search query. In some other embodiments, the first interface may enable the customer to enter a transaction date 354. Typically, the customer may choose a “from” and “to” date associated with the transaction date 354 to search for a savings amount associated with a previous product purchase during that time period. Further, the first interface may enable the customer to retrieve a savings amount associated with at least one of a coupons 358, promotional offers 360, loyalty points 362, or the like using the “savings from” 356 option. In one aspect, the system may enable the customer to retrieve information based on a combination of the search field 352, the transaction date 356, and the savings from 356. In another aspect, the system may enable the customer to retrieve information using the each of the options individually.

FIG. 3B shows an exemplary second interface 350 associated with the system. In one aspect, the second interface presents a set of search results to the customer based on at least the customer request. In some embodiments, the search results may include a product name (e.g., P1, P2, P3, P4), a transaction date, a transaction amount, a savings source (coupons 358, promotional offers 360, loyalty points 362, or the like), and a savings amount. In one aspect, the second interface may present a total savings amount 368 to the customer. In another aspect, the second interface may enable the customer to export the search results for further analysis using the export 366 option.

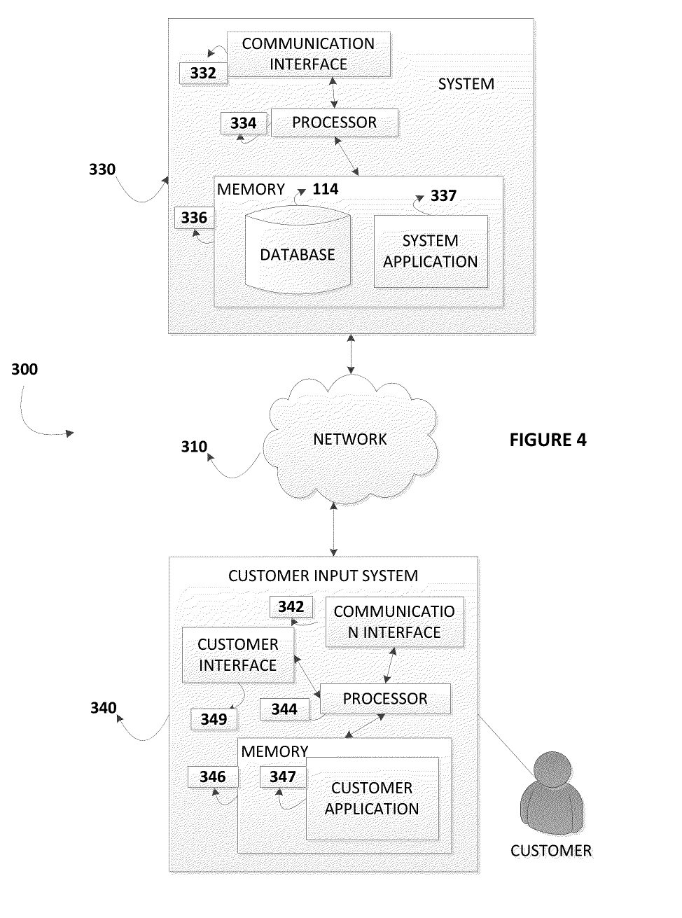

FIG. 4 presents an exemplary block diagram of the system environment 400 for implementing the process flow described in FIG. 1 in accordance with embodiments of the present invention. As illustrated, the system environment 400 includes a network 410, a system 430, and a customer input system 440. Also shown in FIG. 4 is a customer of the customer input system 440. The customer input system 440 may be a mobile device or other non-mobile computing device. The customer may be a person who uses the customer input system 440 to execute a customer application 447. The customer application 447 may be an application to communicate with the system 430, perform a transaction, input information onto a customer interface presented on the customer input system 440, or the like. The customer application 447 and/or the system application 437 may incorporate one or more parts of any process flow described herein.

As shown in FIG. 4, the system 430, and the customer input system 440 are each operatively and selectively connected to the network 410, which may include one or more separate networks. In addition, the network 410 may include a telecommunication network, local area network (LAN), a wide area network (WAN), and/or a global area network (GAN), such as the Internet. It will also be understood that the network 410 may be secure and/or unsecure and may also include wireless and/or wired and/or optical interconnection technology.

The customer input system 440 may include any computerized apparatus that can be configured to perform any one or more of the functions of the customer input system 440 described and/or contemplated herein. For example, the customer may use the customer input system 440 to transmit and/or receive information or commands to and from the system 430. In some embodiments, for example, the customer input system 440 may include a personal computer system (e.g. a non-mobile or non-portable computing system, or the like), a mobile computing device, a personal digital assistant, a mobile phone, a tablet computing device, a network device, and/or the like. As illustrated in FIG. 4, in accordance with some embodiments of the present invention, the customer input system 440 includes a communication interface 442, a processor 444, a memory 446 having an customer application 447 stored therein, and a customer interface 449. In such embodiments, the communication interface 442 is operatively and selectively connected to the processor 444, which is operatively and selectively connected to the customer interface 449 and the memory 446. In some embodiments, the customer may use the customer application 447 to execute processes described with respect to the process flows described herein. Specifically, the customer application 447 executes the process flow described in FIG. 1.

Each communication interface described herein, including the communication interface 442, generally includes hardware, and, in some instances, software, that enables the customer input system 440, to transport, send, receive, and/or otherwise communicate information to and/or from the communication interface of one or more other systems on the network 410. For example, the communication interface 442 of the customer input system 440 may include a wireless transceiver, modem, server, electrical connection, and/or other electronic device that operatively connects the customer input system 440 to another system such as the system 430. The wireless transceiver may include a radio circuit to enable wireless transmission and reception of information. Additionally, the customer input system 440 may include a positioning system. The positioning system (e.g. a global positioning system (GPS), a network address (IP address) positioning system, a positioning system based on the nearest cell tower location, or the like) may enable at least the customer input system 440 or an external server or computing device in communication with the customer input system 440 to determine the location (e.g. location coordinates) of the customer input system 440.

Each processor described herein, including the processor 444, generally includes circuitry for implementing the audio, visual, and/or logic functions of the customer input system 440. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the customer application 447 of the memory 446 of the customer input system 440.

Each memory device described herein, including the memory 446 for storing the customer application 447 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 4, the memory 446 includes the customer application 447. In some embodiments, the customer application 447 includes an interface for communicating with, navigating, controlling, configuring, and/or using the customer input system 440. In some embodiments, the customer application 447 includes computer-executable program code portions for instructing the processor 444 to perform one or more of the functions of the customer application 447 described and/or contemplated herein. In some embodiments, the customer application 447 may include and/or use one or more network and/or system communication protocols.

Also shown in FIG. 4 is the customer interface 449. In some embodiments, the customer interface 449 includes one or more output devices, such as a display and/or speaker, for presenting information to the customer. In some embodiments, the customer interface 449 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the customer. In some embodiments, the customer interface 449 includes the input and display devices of a mobile device, which are operable to receive and display information.

FIG. 4 also illustrates a system 430, in accordance with an embodiment of the present invention. The system 430 may refer to the “apparatus” described herein. The system 430 may include any computerized apparatus that can be configured to perform any one or more of the functions of the system 430 described and/or contemplated herein. In accordance with some embodiments, for example, the system 430 may include a computer network, an engine, a platform, a server, a database system, a front end system, a back end system, a personal computer system, and/or the like. Therefore, the system 430 may be a server managed by the entity. The system 430 may be located at the facility associated with the entity or remotely from the facility associated with the entity. In some embodiments, such as the one illustrated in FIG. 4, the system 430 includes a communication interface 432, a processor 434, and a memory 436, which includes a system application 437 and a structured database 114 stored therein. As shown, the communication interface 432 is operatively and selectively connected to the processor 434, which is operatively and selectively connected to the memory 436.

It will be understood that the system application 437 may be configured to implement any one or more portions of the various customer interfaces and/or process flow described herein. The system application 437 may interact with the customer application 447. It will also be understood that, in some embodiments, the memory includes other applications. It will also be understood that, in some embodiments, the system application 437 is configured to communicate with the structured database 114, the customer input system 440, or the like.

It will be further understood that, in some embodiments, the system application 437 includes computer-executable program code portions for instructing the processor 434 to perform any one or more of the functions of the system application 437 described and/or contemplated herein. In some embodiments, the system application 437 may include and/or use one or more network and/or system communication protocols.

In addition to the system application 437, the memory 436 also includes the structured database 114. As used herein, the structured database 114 may be one or more distinct and/or remote databases. In some embodiments, the structured database 114 is not located within the system and is instead located remotely from the system. In some embodiments, the structured database 114 stores information or data described herein.

It will be understood that the structured database 114 may include any one or more storage devices, including, but not limited to, datastores, databases, and/or any of the other storage devices typically associated with a computer system. It will also be understood that the structured database 114 may store information in any known way, such as, for example, by using one or more computer codes and/or languages, alphanumeric character strings, data sets, figures, tables, charts, links, documents, and/or the like. Further, in some embodiments, the structured database 114 may include information associated with one or more applications, such as, for example, the system application 437. It will also be understood that, in some embodiments, the structured database 114 provides a substantially real-time representation of the information stored therein, so that, for example, when the processor 434 accesses the structured database 114, the information stored therein is current or substantially current.

It will be understood that the embodiment of the system environment illustrated in FIG. 4 is exemplary and that other embodiments may vary. As another example, in some embodiments, the system 430 includes more, less, or different components. As another example, in some embodiments, some or all of the portions of the system environment 400 may be combined into a single portion. Likewise, in some embodiments, some or all of the portions of the system 430 may be separated into two or more distinct portions.

In addition, the various portions of the system environment 400 may be maintained for and/or by the same or separate parties. It will also be understood that the system 430 may include and/or implement any embodiment of the present invention described and/or contemplated herein. For example, in some embodiments, the system 430 is configured to implement any one or more of the embodiments of the process flows described and/or contemplated herein in connection any process flow described herein. Additionally, the system 430 or the customer input system 440 is configured to initiate presentation of any of the customer interfaces described herein.

In accordance with embodiments of the invention, the system 430 may refer to at least one of the systems in FIG. 1, including the merchant computing system 106, the shipping computing system 116, the authentication or authorization computing system 112, the aggregation computing system 110 and database 114, or the email server 108, or vice versa. The customer input system 440 may refer to the customer computing device 102 associated with the customer 100, or vice versa.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for aggregation of savings data from past transactions, the apparatus comprising:
a memory;
a processor; and
a module stored in memory, executable by a processor, and configured to:
receive a request from a customer associated with a financial institution account;
retrieve an information based on the request from a structured database associated with a customer's financial institution account, wherein the information includes a product purchase associated with the customer's purchase transaction;
identify a savings amount associated with the product purchase; and
provide the savings amount to the customer.

2. The apparatus of claim 1, wherein the request includes a transaction date range, a searchable query, and a savings source, where the savings source includes a redeemable coupon, a promotional offer, or loyalty points.

3. The apparatus of claim 1, wherein the savings amount includes individual savings associated with each product purchase in the customer's purchase transaction.

4. The apparatus of claim 1, wherein the savings amount includes an aggregate of individual savings associated with each product purchase in the customer's purchase transaction.

5. The apparatus of claim 1, wherein the savings amount is a percentage of a price amount associated with each product purchased.

6. The apparatus of claim 1, wherein the savings amount is a percentage of a total transaction amount associated with the customer's purchase transaction.

7. The apparatus of claim 1, wherein the savings amount is based on a product name, a product type, a product category, or a product brand.

8. The apparatus of claim 1, wherein the savings amount is based on a transaction method, wherein the transaction method includes a debit card, a credit card, or cash.

9. The apparatus of claim 1, wherein the savings amount is based on an entity associated with the transaction method, wherein the entity is a financial institution.

10. The apparatus of claim 1, wherein the apparatus initiates the presentation of a first customer interface to the customer enabling the customer to enter the request.

11. The apparatus of claim 10, wherein the apparatus initiates the presentation of a second customer interface to the customer based on the request enabling the customer to view the information retrieved.

12. The apparatus of claim 11, wherein the second customer interface includes an export option.

13. The apparatus of claim 1, wherein the module enables the customer to categorize the product purchase.

14. The apparatus of claim 13, wherein the module is further configured to aggregate the savings amount in each category.

15. The apparatus of claim 1, wherein the module is further configured to provide an incentive to the customer based on the savings amount.

16. The apparatus of claim 15, wherein the incentive is based on whether the savings amount has crossed a pre-defined threshold, wherein the pre-defined threshold is specified by the financial institution.

17. The apparatus of claim 16, wherein the pre-defined threshold is made modifiable by the customer.

18. The apparatus of claim 15, wherein incentive includes a discount, a redeemable coupon, a new account incentive, or a credit card reward.

19. A method for aggregation of savings from past transactions, the method comprising:
receiving a request from a customer associated with a financial institution account;
receiving a request from a customer associated with a financial institution account;
retrieving an information based on the request from a structured database associated with a customer's financial institution account, wherein the information includes a product purchase associated with the customer's purchase transaction;
identifying a savings amount associated with the product purchase; and
providing the savings amount to the customer.

20. A computer program product for aggregation of savings from past transactions, the computer program product comprising a non-transitory computer-readable medium comprising code causing a first apparatus to:
receive a request from a customer associated with a financial institution account;
retrieve an information based on the request from a structured database associated with a customer's financial institution account, wherein the information includes a product purchase associated with the customer's purchase transaction;
identify a savings amount associated with the product purchase; and
provide the savings amount to the customer.
